(19) United States
(12) Patent Application Publication
(10) Pub. No.: US 2005/0140160 A1
(43) Pub. Date: Jun. 30, 2005

(54) Reclining seats with trunks for the storing of valuables in truck beds

(76) Inventor: Antonio M. Arias, Panama (PA)

Correspondence Address: John H. Oltman;Oltman, Flynn & Kubler, 915 Middle River Drive #415, Ft. Lauderdale, FL, 33304-3585, US

(21) Appl. No.: 10/748,799

(22) Filed: Dec. 31, 2003

(51) Int. Cl. B60N 2/00

(52) U.S. Cl. 296/64

(57) ABSTRACT

An apparatus comprising a seat structure for two people with a trunk for the safekeeping of valuables within the open-topped cargo compartment of a truck is disclosed. The trunk occupies the entire area underneath the seat structure. The apparatus is designed to be secured removably to either opposite side walls or the front wall of said cargo compartment. The seat structure has reclinable backrests which can be releasably locked in different reclined orientations to secure against theft items outside said trunk but within said cargo compartment. The seat structure can also be turned and releasably locked in different positions so that its occupants face either the rear or the front of the truck, without having to move the trunk underneath. The apparatus has wheels and guide rails to facilitate its movement back and forth, as well as its attachment to different securing locations within the cargo compartment. The apparatus is specially designed to allow one person to seat comfortably while another person has access to the contents of the trunk, including those contents underneath the person sitting down.

### BACKGROUND OF THE INVENTION

1. Field of the Invention

This invention relates generally to the field of seat structures and trunks for the safekeeping of valuables in the open-topped cargo compartment of pickup trucks. More specifically the present invention relates to a seat structure having separate reclinable backrests and separate seat bottoms and a single trunk for the safekeeping of valuables occupying the entire area underneath said seat bottoms. The apparatus is removably secured to opposite side walls or the front wall of the truck's cargo compartment.

2. Description of the Prior Art

There have long been seat structures for the open-topped cargo compartments of pickup trucks. The present applicant has contributed to this art with the disclosure in the following patent:

Arias, U.S. Pat. No. 6,651,469 B2, issued on Nov. 25, 2003, teaches a seat with a backrest which can be reclined backward and down, relative to a bottom of the seat, when said seat is secured to opposite side walls of a truck's cargo compartment.

Besides seats, there also have long been trunks for the safekeeping of valuables in the open-topped cargo compartments of pickup trucks. However, a seat and a trunk in separate assemblies take up a significant portion of the space available for cargo in general in the open-topped cargo compartment of a pickup truck. It is thus an object of the present invention to secure to opposite side walls or the front wall of such compartment such an apparatus which combines both a seat structure and a trunk, one on top of the other, and which would therefore occupy half of the space that a similar seat structure and a similar trunk in separate assemblies would require in the bed of a truck.

It is another object of the present invention to provide a trunk and a seat structure for two occupants which gives either occupant the opportunity to open and close the trunk and access the contents inside the trunk, including those located under the other occupant, while said other occupant remains comfortably seated with his or her backrest upright or reclined backward.

It is a further object of the present invention to provide a seat structure with backrests which can be releasably locked in various reclined orientations to secure against theft items outside said trunk but within the truck's open-topped bed.

It is yet another object of the present invention to provide a seat structure which can be turned from a position in which its occupants in the cargo compartment of a pickup truck face the rear of the vehicle to a position in which they face the front thereof, with means to releasably lock the seat structure in either position.

It is still another object of the present invention to provide an apparatus with a seat structure on top and a trunk on the bottom, with means to turn the seat structure from a position in which its occupants face the rear of a pickup truck to a position in which they face the front thereof, without moving the trunk underneath said seat structure.

It is a further object of the present invention to provide an apparatus comprising a seat structure and a trunk with guide rails and wheels to facilitate the movevement of the apparatus back and forth, as well as its attachment to any one of various securing locations within the cargo compartment of a pickup truck.

### SUMMARY OF THE INVENTION

The principal object of the present invention is to provide a seat structure with a trunk for the safekeeping of valuables in the open bed of pickup trucks. Each seat structure has two separate reclining backrests and two separate seat bottoms and a single trunk occupying the entire area underneath the two seat bottoms. The apparatus has telescopic legs to rest on the bottom wall of the cargo compartments of different pickup trucks, even when it is secured to the side walls of said compartments and said side walls have different heights. A telescopic arm member serves to secure the apparatus to said side walls, even when the distance between them also differs. The apparatus is alternatively secured to the front wall of said cargo compartments. The reclinable backrests and the seat bottoms are carried towards the front of the vehicle as the hinged lids of the trunk are swung up. Either of the two seat occupants can access the contents of the trunk under the other occupant's seat bottom, while said other occupant remains comfortably seated with his or her backrest in an upstanding position or reclined backward in any of various angles. When lowered, the hinged lids can be releasably locked to secure against theft the contents of the trunk. Additionally, the apparatus provides means to releasably lock its backrests in various reclined backward positions to secure against theft items outside said trunk, either in the front or the back portion of the truck's open-topped cargo compartment. The seat bottoms and the backrests can be turned around to allow occupants to face either the front or the back of the vehicle. The apparatus also has guide rails and wheels to facilitate its movement back and forth, as well as its attachment to any one of various securing locations within the truck's cargo compartment.

### BRIEF DESCRIPTION OF THE DRAWINGS

FIG. 1 is a top perspective view of a conventional pickup truck 2.

FIG. 2 shows the apparatus 25 comprising a seat structure with seat bottoms 30 and backrests 31 for two occupants in a first normal position on the top and a trunk 26 on the bottom.

FIG. 3 shows the apparatus 25 with the seat structure in the same first normal position but with the backrests 31 reclined backward and down. Each backrest has its own reclining mechanism.

FIG. 4 shows a key 40 releasably locking the handle 41 which serves to recline (or upswing) a backrest 31. Each backrest has its own reclining handle.

FIG. 5 shows how items in the front of the truck's cargo compartment 4 can be secured against theft.

FIG. 6 shows the apparatus 25 with the seat bottoms 30 and the backrests 31 turned to a second normal position.

FIG. 7 shows how items in the back of the truck's cargo compartment can be secured against theft.

FIG. 8 shows how a seat bottom 30 and its corresponding backrest 31 should be positioned to avoid interference when being turned from one to another normal position.

FIG. 9 shows the seat bottoms 30 and the backrests 31 in the first normal position of FIG. 2 but with the backrests reclined forward and down, instead of backward and down.

FIG. 10 shows the trunk 26 opened with its two separate hinged lids 50 swung up towards the front of the pickup truck 2.

FIG. 11 shows the trunk 26 opened with only one hinged lid 50 swung up towards the front of the pickup truck 2.

FIG. 12 shows that each separate hinged lid 50 of the trunk 26 has its own safety lock 63.

FIG. 13 illustrates the mechanism by which each seat bottom 30 and backrest 31 is lifted and lowered and releasably locked at different heights.

FIG. 14 illustrates the mechanism by which each seat bottom 30 and its corresponding backrest 31 is turned from one normal position to another and releasably locked in either position.

FIG. 15 is a close-up of a telescopic leg 67 and a wheel 65. The apparatus 25 has six such telescopic legs and six such wheels, all resting on the bottom wall of the truck's cargo compartment.

FIG. 16 shows the top edges of opposite side walls 16 and 17 of the truck's cargo compartment 4 with guide rails 69 having a T-shaped upper portion on which brackets 71 and 72 are mounted to secure telescopic arm member R. FIG. 16 further shows that the vertical portion of each guide rail 69 has a series of holes to lock in between brackets 71 and 72 and block their movement and (thus that of the adjoining telescopic arm member R) towards the back and the front of the truck's cargo compartment 4.

FIG. 17 shows how a cable 91 locks a bracket 71 to a guide rail 69 over side wall 16.

FIG. 18 shows how the telescopic arm member R secures the apparatus 25 to guide rails 69 on opposite side walls 16 and 17 of the truck's cargo compartment 4.

FIG. 19 shows a mounting bracket 96 installed on the front wall 18 of the truck's cargo compartment 4 with an adjoining telescopic horizontal arm 98 reaching the middle of said cargo compartment.

FIG. 20 shows how the apparatus 25 is secured to the front wall of the truck's cargo compartment 4 in a manner in which the backrests 31 can be reclined backward and down without any interference either in the first or second normal position.

### DETAILED DESCRIPTION OF THE PREFERRED EMBODIMENTS

Before explaining the present invention in detail it is to be understood that the invention is not limited in its application to the particular arrangements shown and described herein since the invention is capable of other embodiments. Also, the terminology used herein is for the purpose of description and not of limitation.

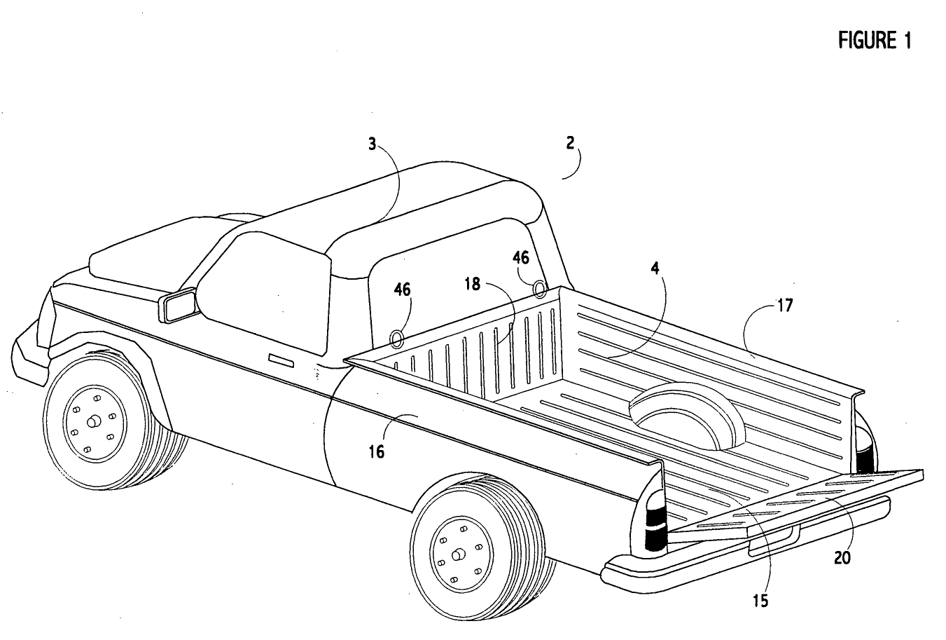

FIG. 1 is a top perspective view of a conventional pickup truck 2 with a cab 3 in the front and an open-topped cargo compartment 4 in the rear thereof. The cargo compartment has a bottom wall 15, and two opposite side walls 16 and 17 extending up from said bottom wall, as well as a front wall 18 adjacent to the rear wall of the cab 3 and a swingable back wall 20 which can be releasably locked to said opposite side walls.

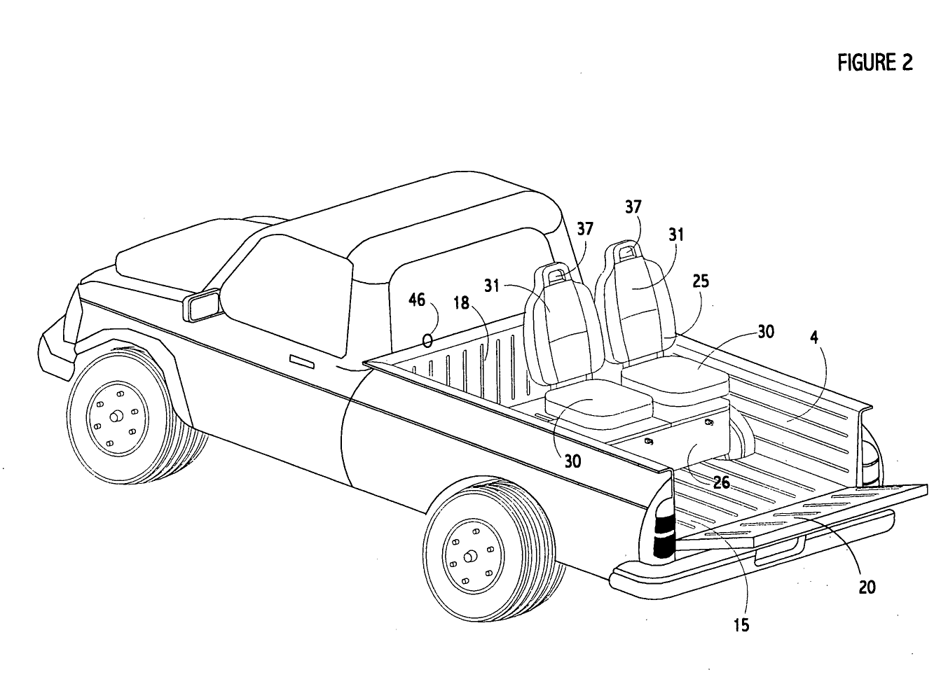

FIG. 2 shows an apparatus 25, comprising a seat structure in an inverted or first normal position and a trunk 26 for the safekeeping of valuables, secured to the pickup truck's open-topped cargo compartment 4. In this inverted or first normal position seat occupants face the rear and not the front of the vehicle. The apparatus is shown with two separate side-by-side seat bottoms 30 for two occupants, and two separate side-by-side backrests 31 in an upright position, one for each occupant, with a single trunk 26 for the safekeeping of valuables occupying the entire area underneath the two seat bottoms. The trunk has two hinged lids (not shown in FIG. 2), one under each seat bottom 30. Each backrest has a loop 37 on the top. The bottom of the trunk 26 has six telescopic legs and six wheels (not shown in FIG. 2) resting on the bottom wall 15 of the truck's cargo compartment 4.

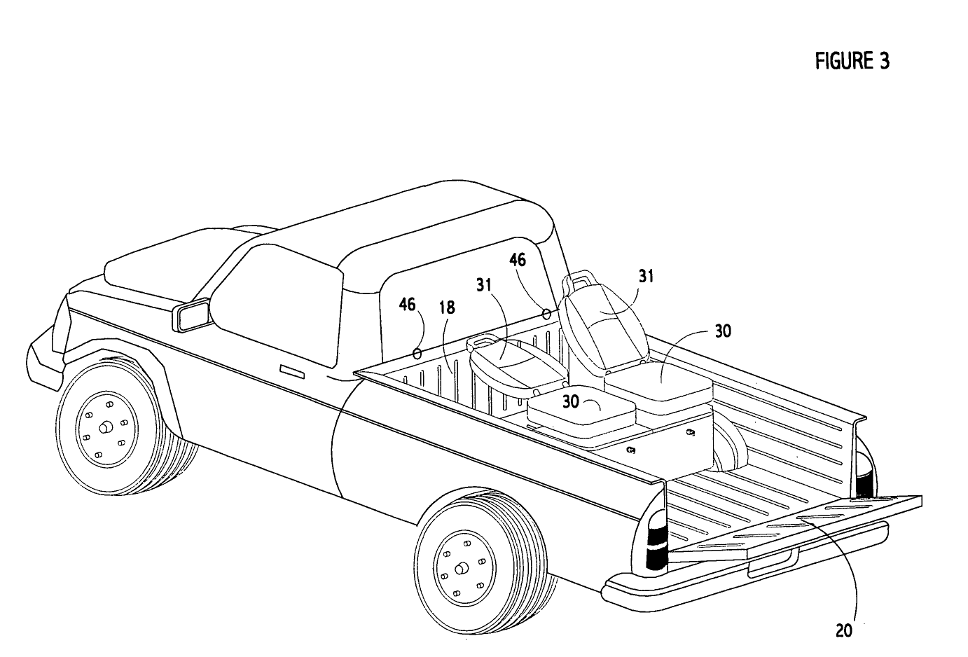

FIG. 3 again shows the apparatus's seat structure in an inverted or first normal position. However, the two separate backrests 31 are no longer upright but reclined backward and down, or reclined not towards but away from the seat bottoms 30. One backrest is shown reclined almost all the way backward and down, while the other backrest is reclined only half of the way backward and down. Each backrest has its own reclining mechanism and can thus be swung backwards and down and then up and to the front independently from the other.

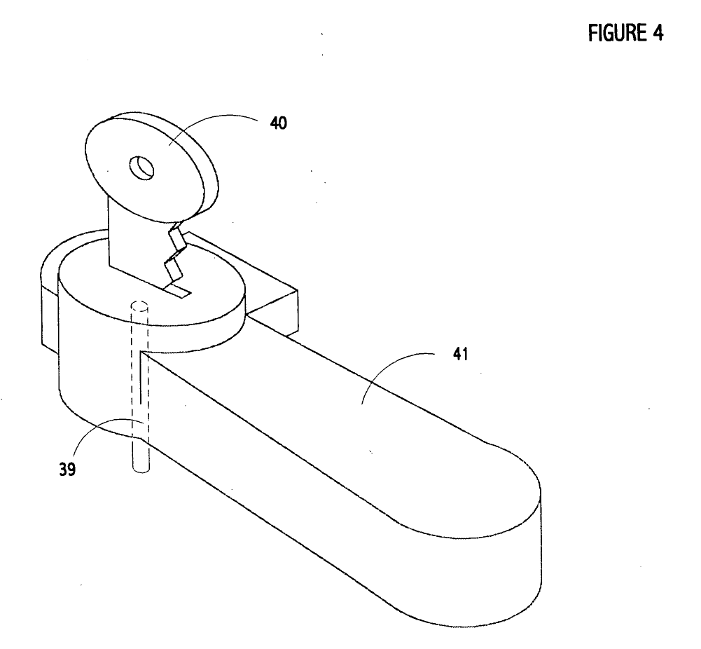

FIG. 4 further shows a key 40 releasably locking the handle 41 which serves to recline (or upswing) a backrest 31. Each backrest 31 has its own reclining handle 41 which can be releasably locked with the same key 40 to block the movement of the backrest. When the reclining handle is locked, the corresponding backrest is also locked. (As the key is turned to a given position a pin 39 is projected outwardly to block the movement of the handle until the key is turned back to retract the pin.)

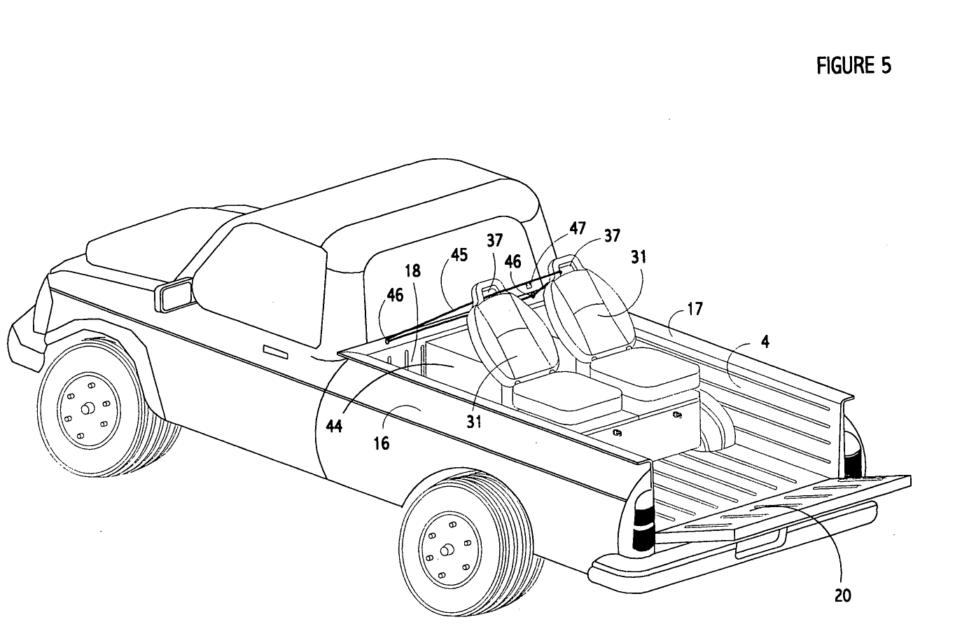

FIG. 5 then shows how items 44 can be secured against theft in the area of the truck's cargo compartment 4 located under the two reclined backward and releasably locked backrests 31 and within two opposite side walls 16 and 17 and the front wall 18 of said cargo compartment 4. The items 44 in the front of the cargo compartment are protected against theft in two different ways. Firstly, the reclining handle 41 of each backrest 31 is releasably locked as shown in FIG. 4, meaning that the two backrests are also locked in their reclined backward orientation. And secondly, the ends of the chain 45 passing through loops 46 on the top edge of the cargo compartment's front wall 18 and the loops 37 on top of each backrest 31 are secured with a padlock 47.

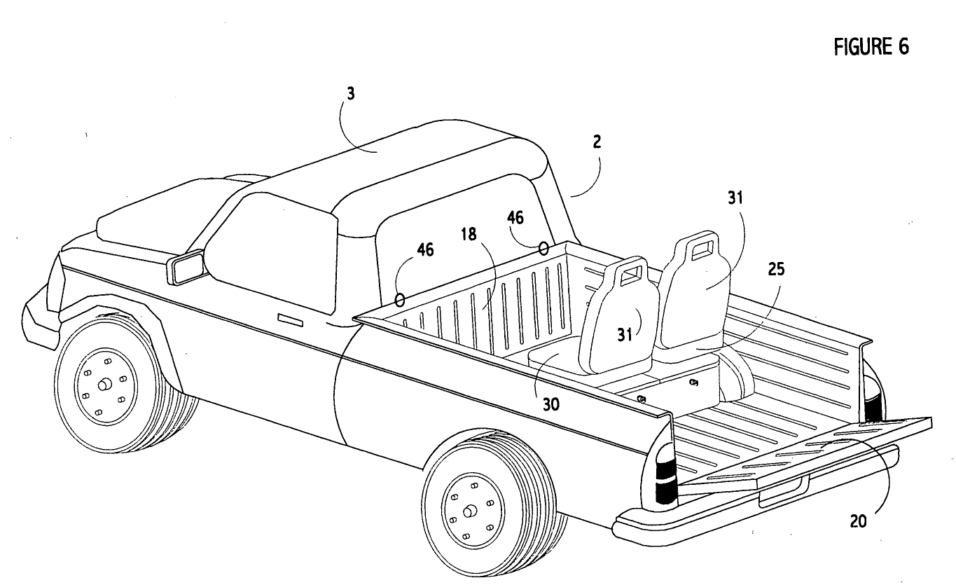

FIG. 6 now shows the apparatus 25 with the seat bottoms 30 and the backrests 31 turned to an about-face or second normal position, so that occupants in the truck's cargo compartment face the cab 3 or front instead of the rear of the vehicle 2.

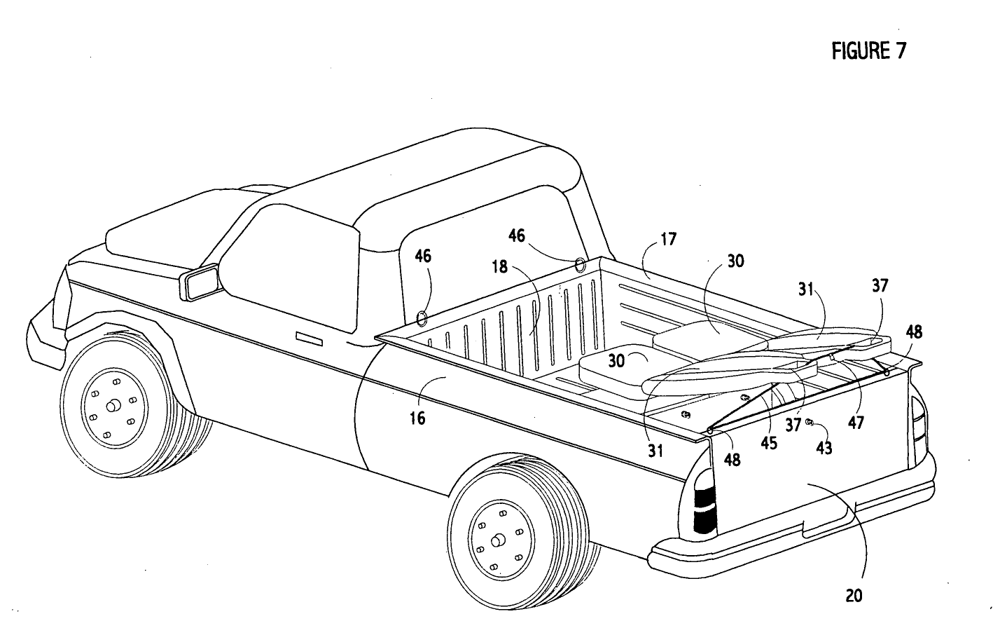

FIG. 7 shows the pair of seat bottoms 30 and backrests 31 in the same turned to the about-face or second normal position of FIG. 6 but with said backrests reclined backward and down, and releasably locked in said orientation, to secure against theft items located under said backrests. In this FIGURE, where the backrests are turned to an about-face position, the protected items are located not in the front (as in FIG. 5) but in the back of the truck's cargo compartment, in the area under said backrests and within two opposite side walls 16 and 17 and the back wall 20 of the truck's cargo compartment 4. Although the backrests 31 are immobilized with the reclining handles 41 releasably locked (see FIG. 4), and the swingable back wall 20 is also secured with its own safety lock 43, this FIGURE illustrates how the protected items can be further secured with said swingable back wall 20 tied to said backrests 31 with a chain 45 passing through loops 48 on the top edge of said back wall and the loops 37 on top of said backrests. The ends of the chain 45 are releasably secured with a padlock 47.

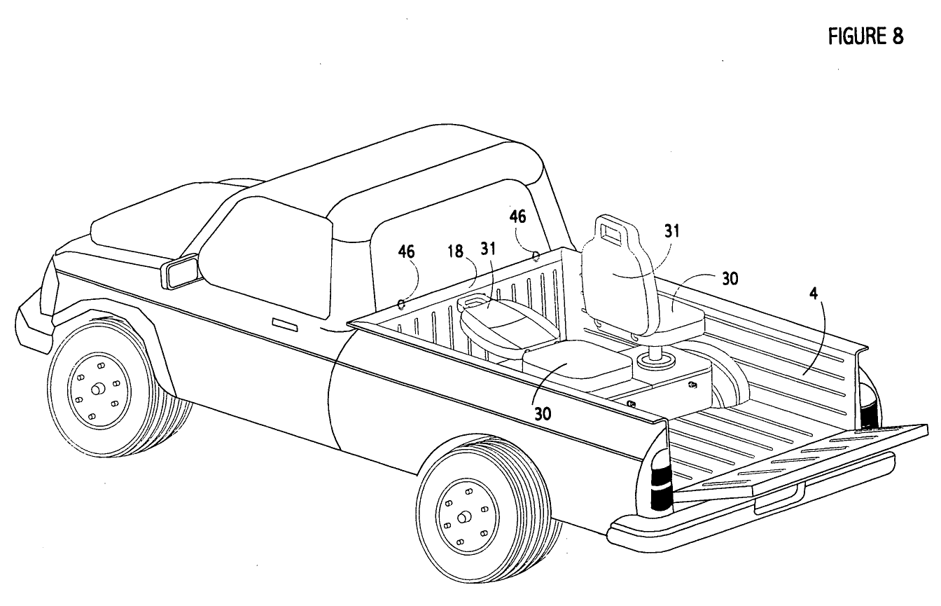

FIG. 8 shows how a seat bottom 30 and its corresponding backrest 31 should be set higher than the other seat bottom 30 and the other backrest 31 to avoid interference when being turned towards an inverted or first normal position or an about-face or second normal position. As also shown, the lower backrest not turning should be reclined backward and down to provide enough room for the turning backrest.

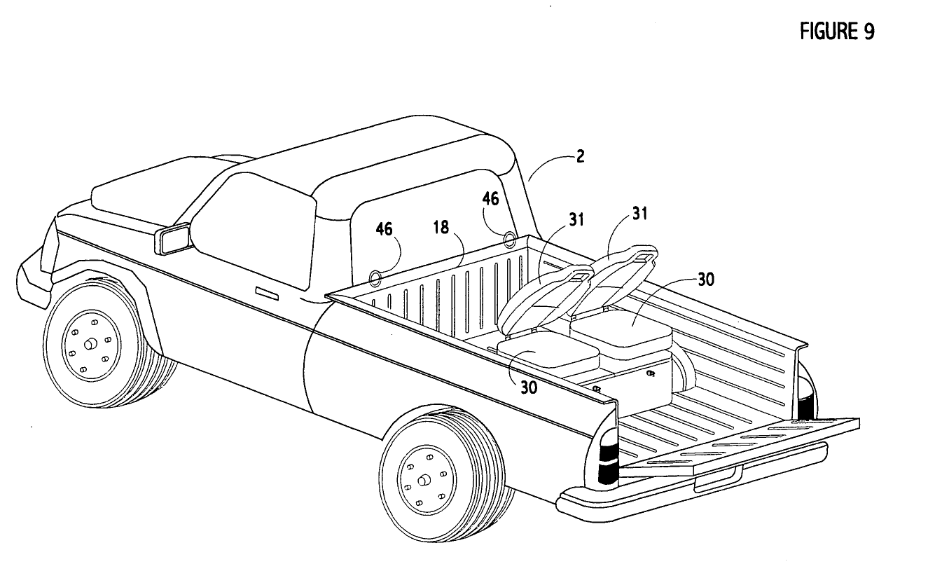

FIG. 9 again shows the pair of backrests 31 in the inverted or first normal position of FIG. 2. However, this time the backrests are reclined and releasably locked not backward and down but forward and down, or reclined not away but towards the seat bottoms 30. The pair of backrests 31 can be lowered and releasably locked in this reclined forward orientation to ensure that strangers do not occupy the seat structure when the pickup truck 2 is unattended. The same key 40 that releasably locks both backrests in their reclined backward position releasably locks them in their reclined forward orientation. FIG. 4 illustrates how this key locks each backrest's reclining handle 41 and thus each backrest 31. The backrests 31 can be reclined forward and down and releasably locked in this orientation either in the inverted or first normal position of this FIGURE or in the about-face or second normal position.

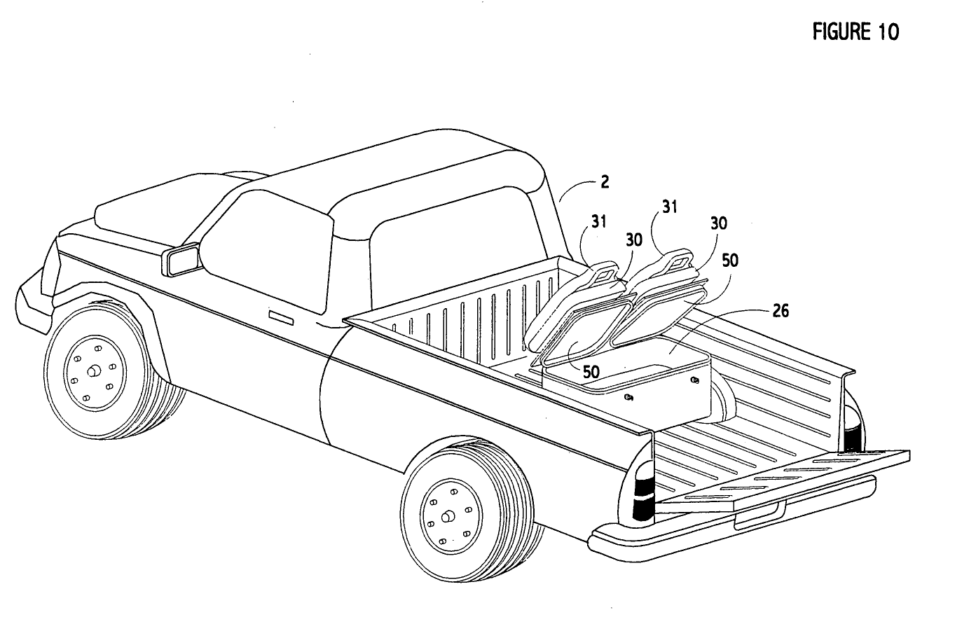

FIG. 10 shows the trunk 26 opened with its two separate hinged lids 50 swung up towards the front of the pickup truck 2, carrying with them both seat bottoms 30 and both backrests 31. The seat bottoms 30 and the backrests 31 are carried towards the front of the vehicle while in position to reassume the inverted or first normal position with the backrests reclined forward, once said hinged lids 50 are swung back down. The trunk 26 could also be opened with both hinged lids 50 swung up towards the front of the pickup truck 2, but with one or both seat bottoms 30 and backrests 31 in position to reassume the about-face or second normal position and the backrests reclined forward, once said lids 50 are swung back down. In either case, once the lids of the trunk 26 are swung back down towards the rear of the vehicle, the trunk is again closed and, once the backrests are adjusted from a reclined forward to an upright or reclined backward orientation, the seat structure can be occupied again, with two occupants in either the inverted or first normal position or the about-face or second normal position, or one occupant in one said position and the other occupant in said other position.

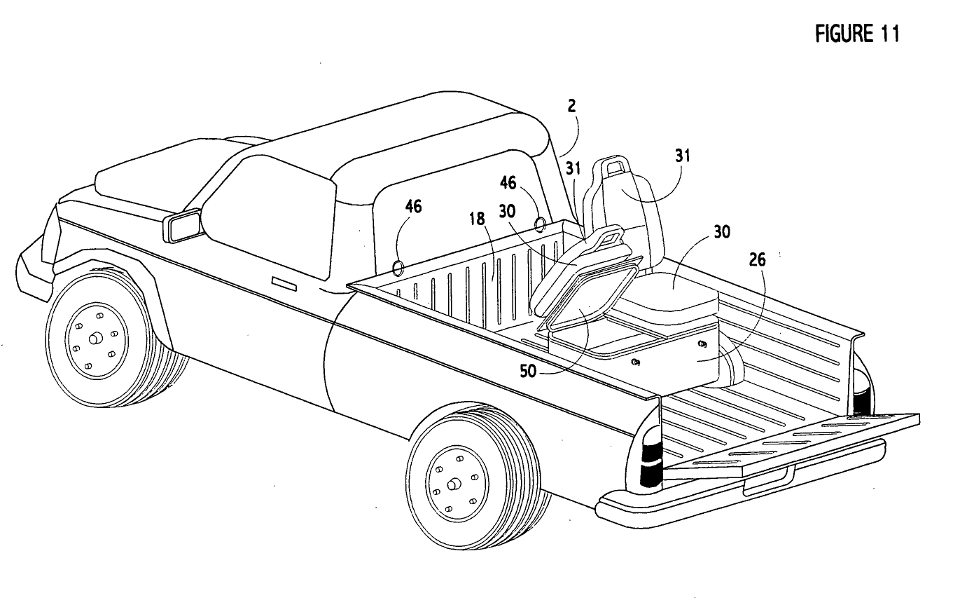

FIG. 11 now shows only one hinged lid 50 of the trunk 26 swung up towards the front of the pickup truck 2, while the other hinged lid 50 continues in place to allow an occupant above to remain seated. In this FIGURE only one side of the trunk 26 is shown opened to give an occupant access to the trunk's contents, including those underneath the seat bottom 30 of another occupant, while said other occupant remains comfortably seated in an inverted or first normal position with his or her backrest 31 upright. Although not shown, said other occupant could also remain seated with his or her backrest reclined backward in a first or second normal position, or adjusted upright in a second normal position.

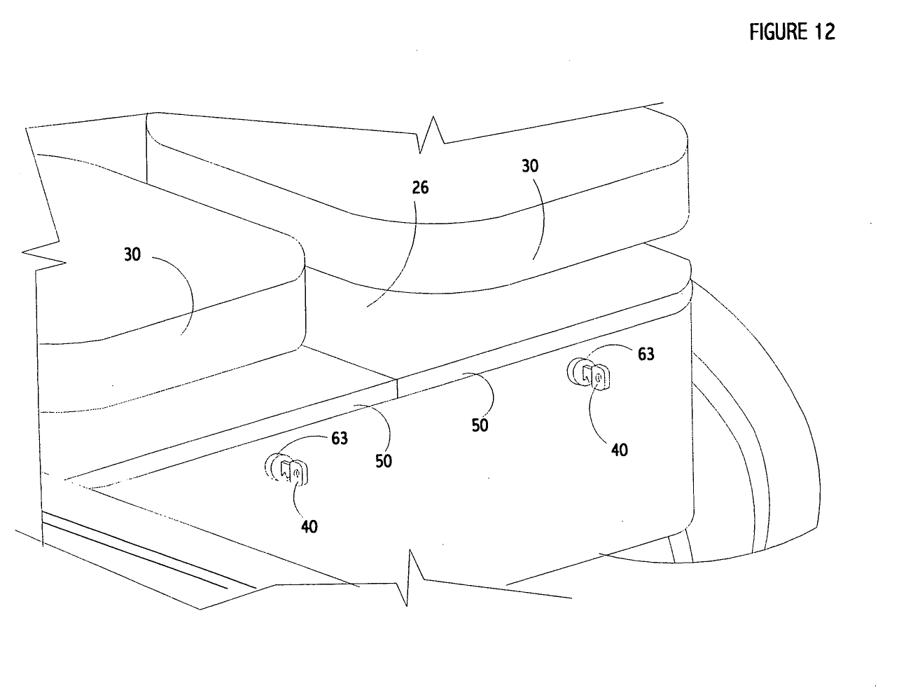

FIG. 12 shows that each separate hinged lid 50 of the trunk 26 has its own safety lock 63. The same key 40 that in FIG. 4 releasably locks the reclining handles 41 of both backrests 31 releasably locks said hinged lids 50.

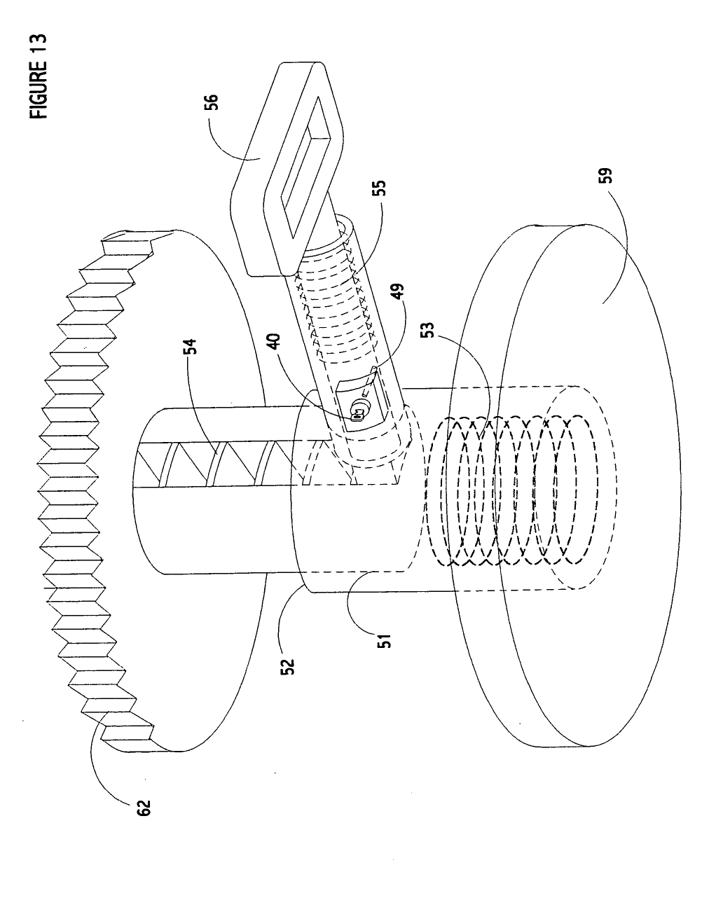

FIG. 13 illustrates the mechanism by which each seat bottom 30 and backrest 31 is lifted and lowered and releasably locked at different heights, to avoid interference with the other seat bottom 30 and the other backrest 31 when turning from one normal position to another, as in FIG. 8. As stated, the trunk 26 has two hinged lids 50, one under each seat bottom 30. The center of the top surface of each said hinged lid 50 has a base 59 with a telescopic leg 51 supporting a striated disk 62, which serves to turn around the corresponding seat bottom 30 and the backrest 31 above. The telescopic leg 51 is comprised of an outer sleeve 52 having an inner spring 53 in the bottom and a striated inner shaft 54 on the top. Another spring 55 inside a first horizontal lever 56, also underneath the same seat bottom 30, applies pressure perpendicularly against the striated inner shaft 54 and locks it at a given height as it is also pressed upward by the inner spring 53 in the bottom of the telescopic leg 51. As this first horizontal lever 56 is pulled out manually its spring 55 retracts and the horizontal lever moves out of the way to allow the striated inner shaft 54 to move up or down, until the horizontal lever is again released and its spring applies renewed pressure against the striated inner shaft and locks it at a new height. The seat bottom 30 and the corresponding backrest 31 are then lowered as the weight of an occupant press them downward against the inner spring 53 on the bottom of the telescopic leg 51, provided the horizontal lever 56 is also pulled out manually; and lifted as an occupant stands up to free them from his or her weight, allowing the inner spring 53 to push them upward, provided the horizontal lever 56 is also pulled out manually. As further shown in this FIGURE, the horizontal lever 56 can be releasably locked with a key 40 to ensure that strangers do not pull it out to raise or lower a seat bottom 30 and a corresponding backrest 31 when the pickup truck 2 is unattended. (As the key is turned to a given position a pin 49 is projected outwardly to block the movement of the lever until the key is turned back to retract the pin.)

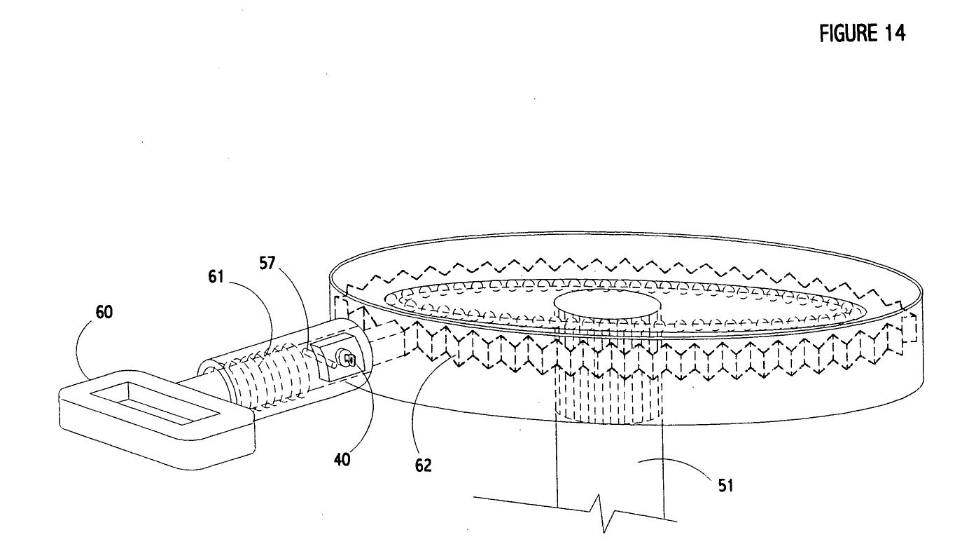

FIG. 14 illustrates the mechanism by which each seat bottom 30 and its corresponding backrest 31 are turned from an inverted or first normal position to an about-face or second normal position (and viceversa) and releasably locked in either position. A spring 61 inside a second horizontal lever 60 under each seat bottom 30 applies pressure against a striated disk 62 which otherwise is free to turn around with the seat bottom 30 and the backrest 31 on top. As this second horizontal lever 60 is pulled out manually its spring 61 retracts and the lever moves out of the way to allow the striated disk 62 to turn around together with the seat bottom 30 and the backrest 31. As further shown in this FIGURE, this second horizontal lever 60 can be releasably locked with a key 40 to ensure that strangers do not pull it out when the pickup truck 2 is unattended. (As the key is turned to a given position a pin 57 is projected outwardly to block the movement of the lever until the key is turned back to retract the pin.)

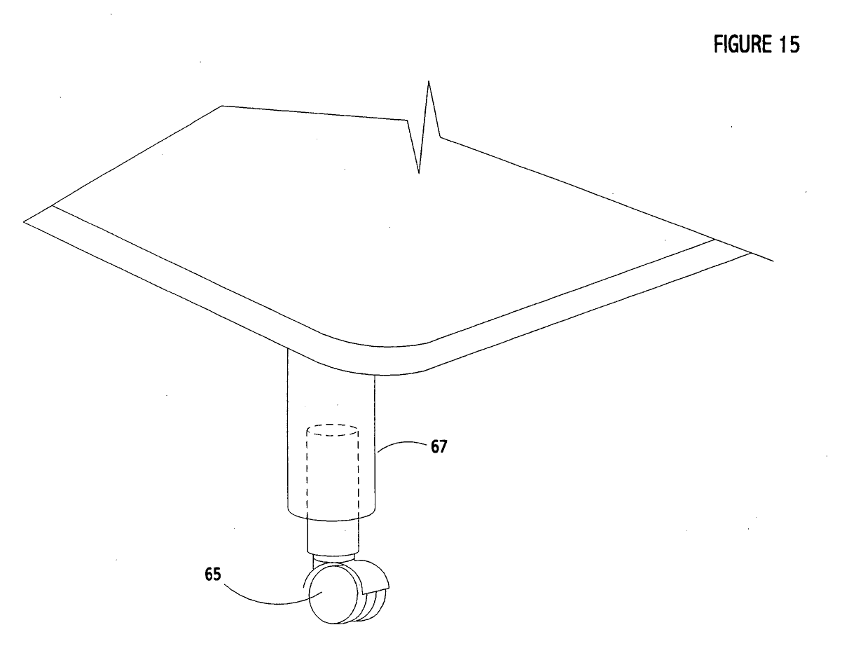

FIG. 15 is a close-up of a telescopic leg 67 and a wheel 65. The apparatus 25 has six such telescopic legs 67, each one with a wheel 65 underneath, all resting on the cargo compartment's bottom wall 15 to facilitate the movement of the apparatus back and forth and secure it to different attachment points within the cargo compartment. The telescopic legs make it possible to secure the apparatus to the opposite side walls of cargo compartments of different pickup trucks having different heights and still rest the apparatus on the bottom wall 15 of said cargo compartments.

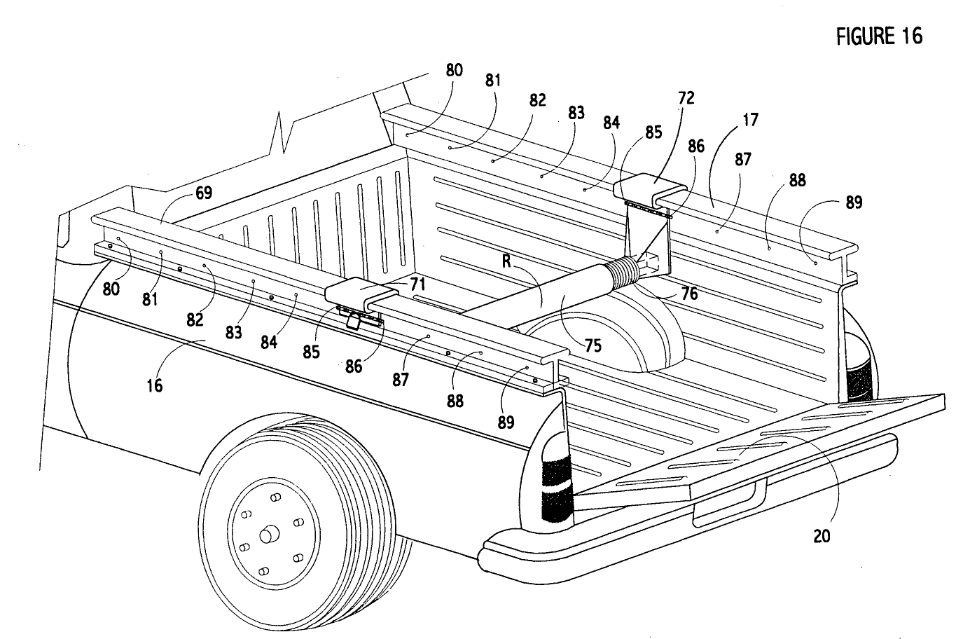

FIGS. 16 thru 18 show a first preferred means of securing the apparatus 25 to the truck's cargo compartment 4. In FIG. 16 the top edges of side walls 16 and 17 of the cargo compartment 4 are shown with stainless steel guide rails 69 having a T-shaped upper portion on which brackets 71 and 72 are mounted. With said guide rails, brackets 71 and 72 are slid back and forth alongside the interior face of side walls 16 and 17 to be secured to any one of various attachment points (or pairs of holes). The brackets are also disengaged from the guide rails 69 when slid all the way towards the back wall 20 of the cargo compartment 4. The lower portion of bracket 71 mounted on guide rail 69 affixed to side wall 16 has a rectangular opening or recess to receive a rectangular end piece of a cylindrical hollow tube or outer sleeve 75; and the lower portion of bracket 72 mounted on guide rail 69 affixed to side wall 17 has an identical rectangular opening or recess to likewise receive an identical rectangular end piece of a striated inner shaft or rod 76 which is snugly but slidably received in sleeve 75. The sleeve 75 and the rod 76 thus comprise a telescopic arm member R with the adjoining bracket 71 on one end mounted on a guide rail 69 over side wall 16 and the adjoining bracket 72 on another end mounted on another guide rail 69 over the other side wall 17.

FIG. 16 further shows that the vertical portion of each guide rail 69 has a series of holes, each one with an engraved number from 80 to 89 to a side thereof. A cable 91 can be passed through a pair of said holes to block the movement of a bracket 71 or 72 towards both the back and the front of the cargo compartment 4.

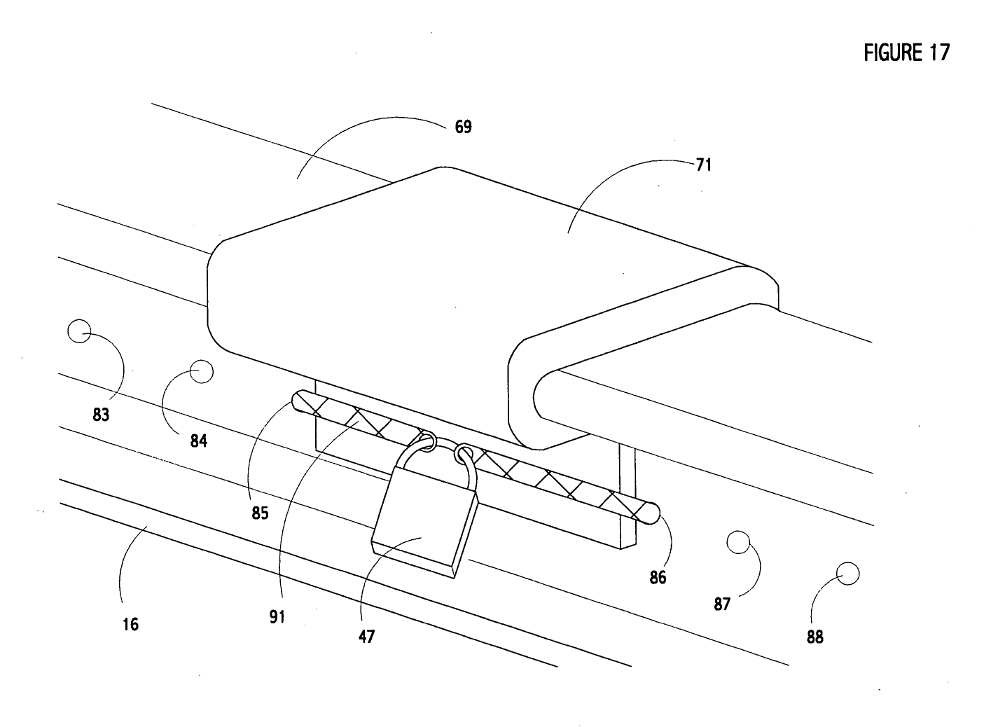

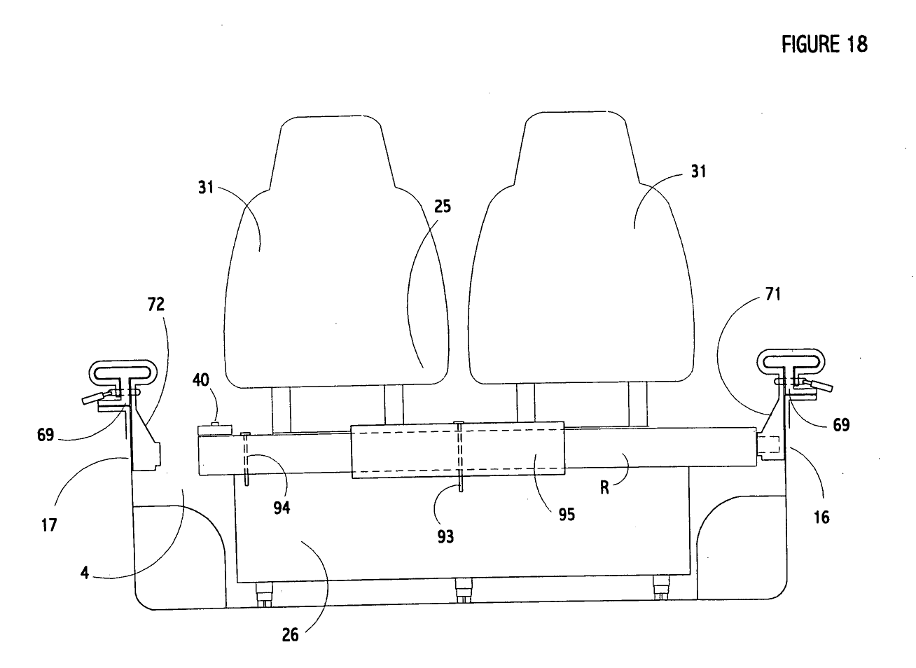

FIG. 17 thus shows a cable 91 passing through holes 85 and 86 on guide rail 69 over side wall 16, to lock in between bracket 71. The portion of cable 91 passing through hole 85 on guide rail 69 over side wall 16 blocks the movement of the bracket 71 towards the front of the cargo compartment 4, while the portion of said cable 91 passing through hole 86 in said guide rail blocks the movement of said bracket towards the back of said compartment. As further shown, once the bracket 71 is blocked in both directions, the ends of cable 91 passing through holes 85 and 86 are releasably locked with a padlock 47. Although not shown in this FIGURE, the counterpart bracket 72 can likewise be locked in between holes 85 and 86 on the counterpart guide rail 69 over the opposite side wall 17 of the cargo compartment 4, to then secure telescopic arm member R to said brackets and to said opposite side walls 16 and 17 (as illustrated in the preceding FIG. 16 and in the next FIG. 18).

FIG. 18 further shows brackets 71 and 72 blocked between holes 85 and 86 on guide rails 69 over opposite side walls 16 and 17, as the adjoining telescopic arm member R passes through a loop 95 on the rear of the trunk 26 and underneath the backrests 31, to retain in place the apparatus 25 within the truck's cargo compartment 4. As shown, the loop 95 is located well underneath the backrests 31 to allow the backrests to recline backward and down without any interference in their inverted or first normal position. As the seat bottoms 30 and the backrests 31 are subsequently turned to the about-face or second normal position, the loop 95 and the telescopic arm member R remain in place. The extensible and retractable telescopic arm member R makes it possible to secure the apparatus 25 to opposite side walls 16 and 17 of cargo compartments of different pickup trucks, even when the separation of said side walls differ. As also shown in FIG. 18, a pin 93 extends through coinciding holes on the loop 95 and the outer sleeve 75 of the telescopic arm member R. The purpose of the pin is to prevent the apparatus 25 from sliding towards either side wall 16 or 17 of the cargo compartment 4. The pin 93 is secured removably. Another pin 94 extends through coinciding holes on the outer sleeve 75 and the striated inner shaft or rod 76. The purpose of this other pin is to secure removably the telescopic arm member R to brackets 71 and 72. The striated inner shaft 76 is also releasably locked to the outer sleeve 75 with the same key 40 that releasably locks the reclining handles 41 and the first and second horizontal levers 56 and 60 respectively, as well as the hinged lids 50 (see FIGS. 4, 13, and 14).

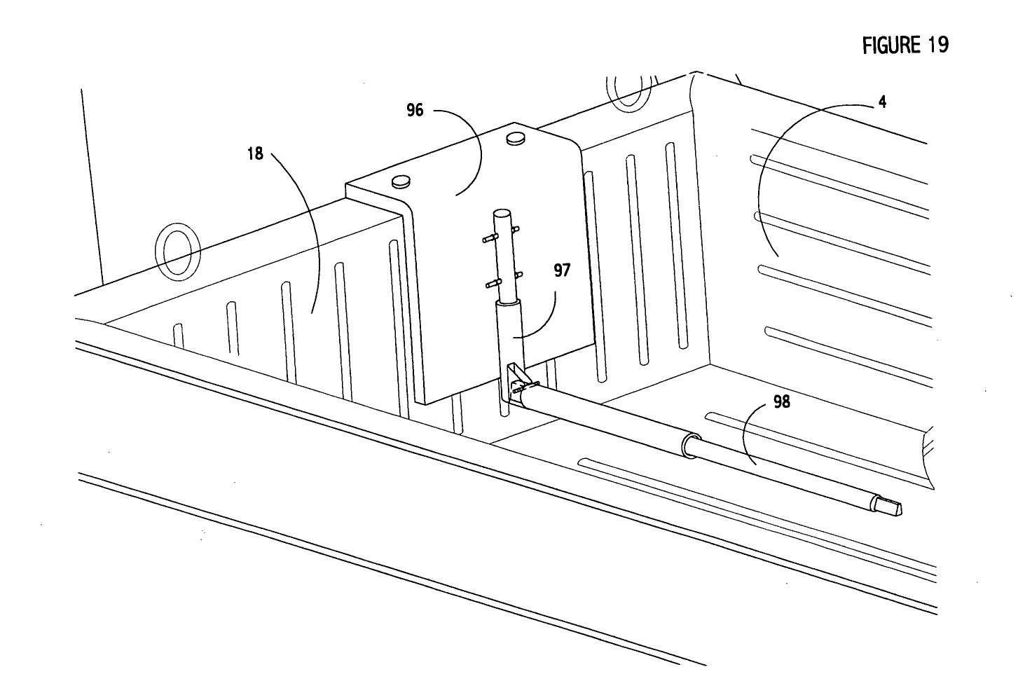

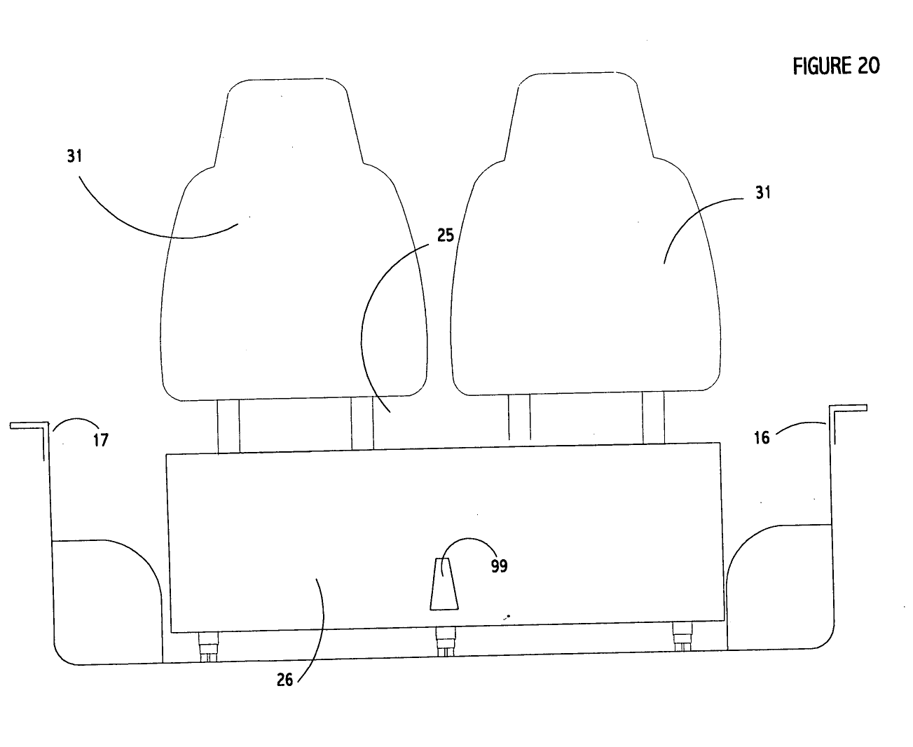

FIGS. 19 and 20 show a second preferred means of securing the apparatus 25 to the truck's cargo compartment 4. FIG. 19 shows a stainless steel mounting bracket 96 having a telescopic vertical arm 97 with a telescopic horizontal arm 98 in its base. The mounting bracket 96 is installed on the front wall 18 of the truck's cargo compartment 4 with the adjoining telescopic horizontal arm 98 reaching the middle of the cargo compartment.

FIG. 20 then shows a triangular-shaped recess or joint 99 on the bottom of the rear of the apparatus 25, where the telescopic horizontal arm 98 is received to secure the apparatus to the front wall of the truck's cargo compartment 4. The telescopic horizontal arm 98 is secured removably to the joint 99 with suitable means (e.g., screws). As shown, neither said joint 99 nor said telescopic horizontal arm 98 interfere with the backrests 31 when reclined backward and down in the inverted or first normal position. As the seat bottoms 30 and the backrests 31 are later turned to the about-face or second normal position, the joint 99 and the telescopic horizontal arm 98 remain in place. The telescopic horizontal arm 98 can also be retracted to secure the apparatus 25 closer to the front wall 18 of the cargo compartment 4.

1. In combination with a truck with a cargo compartment having a bottom wall, front and back walls and opposite side walls extending up from said bottom wall, at least one seat structure having a reclinable backrest structure pivoted to swing back and down which can be reclined back and down, relative to a bottom of the seat structure, and releasably locked in said orientation when said seat structure is secured to said compartment, to protect against theft items located at least partially under said backrest structure and at least partially within said compartment.

2. In combination with a truck with a cargo compartment having a bottom wall, front and back walls and opposite side walls extending up from said bottom wall, at least one seat structure having a reclinable backrest structure pivoted to swing back and down which can be reclined back and down, relative to a bottom of the seat structure, when said seat structure is secured to said compartment, and means for securing said seat structure to said front wall of said compartment.

3. In combination with a truck with a cargo compartment having a bottom wall, front and back walls and opposite side walls extending up from said bottom wall, at least one seat structure for at least two people having at least two reclinable backrests, each one with its own independent mechanism to swing back and down, relative to a bottom of the seat structure, and at least two seat bottoms, each one over at least one hinged lid of at least one trunk occupying an area under at least two of said seat bottoms, so that at least one person can occupy said seat structure while another person has access to the contents of said trunk.

4. In combination with a truck with a cargo compartment having a bottom wall, front and back walls and opposite side walls extending up from said bottom wall, an apparatus comprising at least one seat structure having a reclinable backrest structure pivoted to swing back and down which can be reclined back and down, relative to a bottom of the seat structure, when said apparatus is secured to said compartment, and at least one trunk, with guide rails to facilitate the attachment of the apparatus to any one of two or more securing locations within said compartment.

5. In combination with a truck with a cargo compartment having a bottom wall, front and back walls and opposite side walls extending up from said bottom wall, at least one seat structure having a reclinable backrest structure pivoted to swing back and down which can be reclined back and down, relative to a bottom of the seat structure, when said seat structure is secured to said compartment, and having guide rails to facilitate the attachment of the seat structure to any one of two or more securing locations within said compartment.

6. In combination with a truck with a cargo compartment having a bottom wall, front and back walls and opposite side walls extending up from said bottom wall, at least one seat structure with legs in the bottom and means to turn from a position in which its occupants face the back wall of said compartment to a position in which they face the front wall of said compartment, and means to releasably lock the seat structure in either one of said positions, without moving said legs in the bottom.

7. In combination with a truck with a cargo compartment having a bottom wall, front and back walls and opposite side walls extending up from said bottom wall, an apparatus having a at least one seat structure on top and at least one trunk on the bottom, and means to turn said seat structure from a position in which its occupants face the back wall of said compartment to a position in which they face the front wall of said compartment, and means to releasably lock said seat structure in either one of said positions, without moving said trunk.

8. In combination with a truck with a cargo compartment having a bottom wall, front and back walls and opposite side walls extending up from said bottom wall, an apparatus comprising at least one seat structure having at least two reclinable backrest structures pivoted to swing down and towards the front wall of said compartment and also down and towards the back wall of said compartment, relative to a bottom of the seat structure, and at least one trunk with at least two separate lids underneath at least two separate bottoms of said seat structure, which can be separately swung up towards the front wall of said compartment, carrying with them said backrest structures in such orientation that when said lids are swung back down towards the back wall of said compartment said backrest structures are reclined down.

9. In combination with a truck with a cargo compartment having a bottom wall, front and back walls and opposite side walls extending up from said bottom wall, an apparatus comprising at least one seat structure having a reclinable backrest structure pivoted to swing back and down, relative to a bottom of the seat structure, and at least one trunk, and means for securing said apparatus to said opposite side walls of said compartment;
wherein said reclinable backrest structure can be reclined back and down, relative to a bottom of the seat structure, when said apparatus is secured to said opposite side walls of said compartment.
